(19) United States
(12) Patent Application Publication
(10) Pub. No.: US 2015/0034623 A1
(43) Pub. Date: Feb. 5, 2015

(54) HEATER UNIT

(71) Applicant: CANON KABUSHIKI KAISHA, Tokyo (JP)

(72) Inventors: Yousuke Hata, Ichikawa-shi (JP); Kazumi Sato, Kashiwa-shi (JP); Takeyuki Suda, Nagareyama-shi (JP); Hirohisa Kato, Toride-shi (JP); Shinya Suzuki, Toride-shi (JP); Manabu Koseki, Sakuragawa-shi (JP); Toshiyuki Abe, Toride-shi (JP); Toshifumi Kakutani, Abiko-shi (JP)

(21) Appl. No.: 14/447,422

(22) Filed: Jul. 30, 2014

(30) Foreign Application Priority Data
Aug. 1, 2013 (JP) 2013-160335

(51) Int. Cl. G03G 15/20; H05B 3/24; H05B 3/56

(52) U.S. Cl. CPC G03G 15/2039; H05B 3/56; H05B 3/24
USPC 219/216; 219/530

(57) ABSTRACT

In a heater unit for heating a sheet stored in a cassette, respective heating wires of a plurality of heater wires are arranged along an outer periphery of a heat transfer plate so as not to overlap each other, respective power supply wires of the plurality of heater wires are arranged inside a path formed by the heating wires, and both ends of each of the plurality of heater wires are connected to a connector.

### BACKGROUND OF THE INVENTION

1. Field of the Invention

The present invention relates to a heater for a cassette used to store recording sheets in an image forming apparatus.

2. Description of the Related Art

Conventionally, an image forming apparatus such as a copying machine has been provided with a cassette in which a plurality of recording sheets is stacked and stored so that the sheets are fed to an image forming unit. The sheets stored in the cassette, when absorbing moisture due to influences of surrounding environments, stick to each other, and this tends to cause a sheet conveyance failure such as a paper jam. To cope with this, usually, in an image forming apparatus that operates in an environment that could cause the sheets to absorb moisture, a heater is provided in or near the cassette so as to warm and dry the sheets stored therein.

Japanese Patent Application Laid-Open No. 2012-247672 discusses a heater unit including a configuration in which a heating element is arranged in a meandering manner on a metal plate and air is caused to pass through the space between the meandering wiring lines thus arranged. By providing the heater unit near the cassette, the sheets stored therein is prevented from absorbing moisture, whereby preventing malfunctions such as paper jams from occurring.

Here discussed is a universal heater unit having a configuration in which two heating elements are arranged in one heater unit. A universal heater unit refers to a heater unit which can be used under both 100 volt and 200 volt commercial power supply systems and has no specific destination. Conventionally, heater units have different types of power supplies having different specifications depending on the destination (hereinafter referred to as destination-specified power supply) and are selectively used. For example, a heater unit for 100 V is mounted to a copying machine having power supply specification of 100 V, and a heater unit for 230 V is mounted to a copying machine having power supply specification of 230 V.

However, there is a possibility that in the process of mounting heater units having specific power supply voltages, an improper heater unit could be installed by mistake. To prevent such a mistake and to achieve cost reduction, universal heater units have been increasingly used.

A universal heater unit requires at least two heating elements to be provided therein. Therefore, in a case where two heating elements are arranged in a meandering manner as is the case with the configuration discussed in Japanese Patent Application Laid-Open No. 2012-247672, respective regions heated by the two heating elements overlap each other, thereby increasing temperature unevenness in the heating for the recording sheets stored in the cassette, resulting in unevenness in the dried state of the sheet surface. Further, there occurs also a problem that a redundant wiring arrangement leads to an increase in the cost of the heater unit.

### SUMMARY OF THE INVENTION

The present invention is directed to a universal heater unit which achieves cost reduction while suppressing temperature unevenness.

According to an aspect of the present invention, a heater unit for heating a sheet stored in a cassette includes a plurality of heater wires each of which includes a heating wire and a power supply wire connected to the heating wire in series and configured to energize the heating wire, a connector configured to supply power to the plurality of heater wires, and a heat transfer plate on which the plurality of heater wires is arranged and through which heat of the plurality of heater wires is transferred. Further, the respective heating wires of the plurality of heater wires are arranged substantially along an outer periphery of the heat transfer plate so as not to overlap each other, the respective power supply wires of the plurality of heater wires are arranged inside a path formed by the respective heating wires of the plurality of heater wires, and both ends of each of the plurality of heater wire are connected to the connector.

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus.

FIG. 2 is a block diagram of an image forming apparatus.

FIGS. 3A, 3B, 3C, and 3D each illustrate a configuration of a heater unit.

FIG. 4 illustrates a wiring arrangement of a heater unit.

FIGS. 5A and 5B each illustrate a wiring arrangement of a conventional heater unit.

FIGS. 6A, 6B, and 6C each illustrate another wiring arrangement of the heater unit.

FIG. 7 illustrates still another wiring arrangement of the heater unit.

### DESCRIPTION OF THE EMBODIMENTS

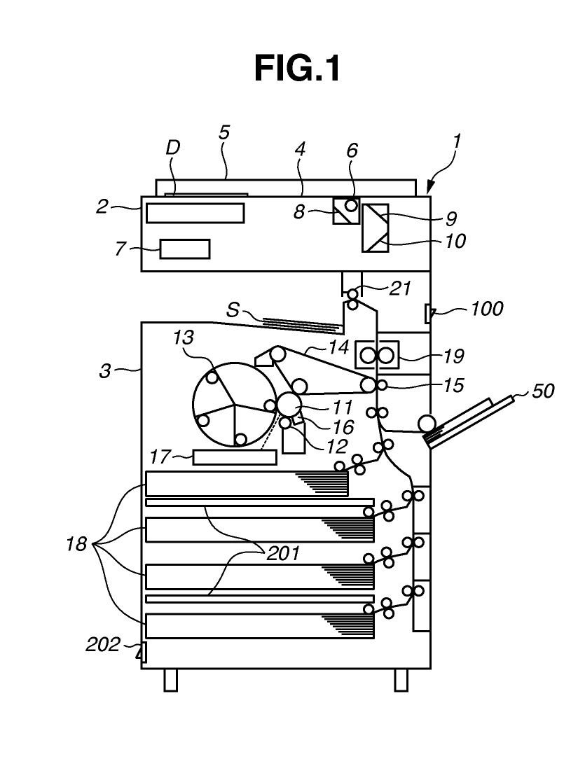

FIG. 1 illustrates a cross-sectional view of an image forming apparatus according to a present exemplary embodiment.

An image forming apparatus 1 includes an image reading unit 2 that reads an original document image, and an image forming unit 3 that forms an image on a recording sheet. In the image reading unit 2, a platen 4 formed by a transparent glass plate is provided. A document D is placed at a predetermined position on the platen 4 with an image surface thereof facing downward, and is pressed and fixed by a document cover 5. Below the platen 4, there are provided a lamp 6 that illuminates the document D, and an optical system that guides a light image of the document D thus illuminated toward an image processing unit 7, the optical system including reflection mirrors 8, 9, and 10. The lamp 6 and the reflection mirrors 8, 9, and 10 move at a predetermined speed to scan the document D. A document feeding apparatus may be provided on the platen 4.

The image forming unit 3 includes a photosensitive drum 11, a primary charging roller 12, a developing unit 13, an intermediate transfer belt 14, a transfer roller 15, and a cleaner 16. A laser unit 17 irradiates the photosensitive drum 11 with a light beam modulated based on image data, causing an electrostatic latent image to be formed on a surface of the photosensitive drum 11. The primary charging roller 12 uniformly charges the surface of the photosensitive drum 11 before the irradiation of the laser beam.

The developing unit 13 causes each color toner of magenta (M), cyan (C), yellow (Y), and black (K) to attach to the electrostatic latent image formed on the surface of the photosensitive drum 11, thereby forming a toner image. The toner image developed on the surface of the photosensitive drum 11 is transferred onto the intermediate transfer belt 14, and the toner image on the intermediate transfer belt 14 is transferred onto a recording sheet S by the transfer roller 15. After the toner image is transferred onto the intermediate transfer belt 14, the cleaner 16 removes toner remaining on the photosensitive drum 11.

The recording sheet S is supplied from any of cassettes 18 or a manual feed tray 50. On the downstream side of the image forming unit 3, a fixing unit 19 is provided to fix the toner image on the recording sheet S that is conveyed thereto. The recording sheet S on which the toner image is fixed by the fixing unit 19 is discharged onto a discharge tray by a discharge roller pair 21.

A cassette heater unit 201 is provided between the cassettes 18. Heating elements provided in the cassette heater unit 201 generate heat, thereby warming the ambient environment thereof. The recording sheet S stored in the cassette 18 is influenced by the ambient environment where the image forming apparatus 1 is located. For example, in a case where humidity in the ambient environment is high, the recording sheet S absorbs moisture in the air, increasing the moisture content. As the moisture content of the recording sheet S increases, the following problems occur. First of all, the degree of sticking the recording sheets S to one another increases, and a plurality of recording sheets S overlapping one another tends to be conveyed at once from the cassette 18. As a result, a sheet conveyance failure such as a paper jam occurs. Further, when the recording sheet S having a high moisture content passes through the fixing unit 19, where the recording sheet S is heated rapidly, the moisture in the recording sheet S is vaporized and condensation is likely to occur in the sheet conveyance path, whereby a sheet conveyance failure occurs. Further, the increase in the moisture content causes a significant change in the electric resistance value of the recording sheet S, whereby a transfer failure may possibly occur when a toner image is transferred onto the recording sheet S. In order to prevent these problems from occurring, the cassette heater unit 201 warms and dries the recording sheet S in the cassette 18. This allows the moisture content of the recording sheet S to be maintained so that the moisture content should not rise too high.

A cassette heater switch 202 switches on/off the cassette heater unit 201. The cassette heater switch 202 is provided independently of a main power supply switch 100 of the image forming apparatus 1, and even if, for example, the power supply of the image forming apparatus 1 is in an off state, a service person or a user can turn the cassette heater unit 201 on/off at an arbitrary timing by using the cassette heater switch 202. The moisture absorption of the recording sheet S is more likely to occur as the recording sheet S is left in the cassette 18 for a longer period of time. For example, if the recording sheet S is left overnight in the image forming apparatus 1 with the power supply thereof turned off in an environment where the air conditioning is turned off in an office or the like, the recording sheet S in the cassette 18 results in absorbing moisture due to the ambient environment. To prevent this from occurring, the cassette heater unit 201 is configured to be turned on/off by the cassette heater switch 202 which is provided independently of the main power supply switch 100. Therefore, even if the main power supply switch 100 of the image forming apparatus 1 is turned off in an office at night where the air conditioning is turned off, the dried state of the recording sheet S can be maintained by using the cassette heater unit 201.

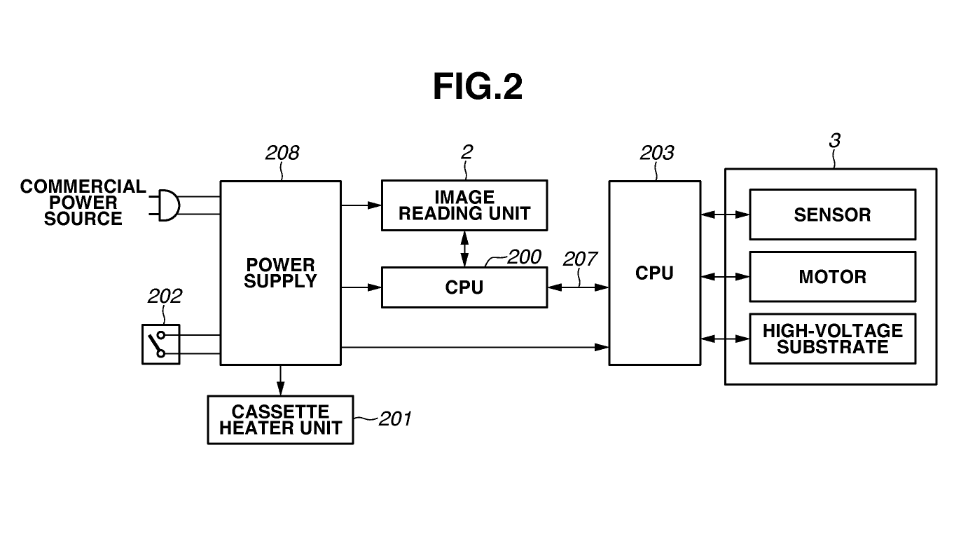

FIG. 2 is a control block diagram of the image forming apparatus 1.

The image forming apparatus 1 includes a main control unit 200, the cassette heater unit 201, the cassette heater switch 202, a driving control unit 203, and a power supply 208. The power supply 208 receives power from a commercial alternate current power source, and supplies the power to each control unit. Switching on/off of power supply to the cassette heater unit 202 is performed independently of the main power supply switch 100 by the cassette heater switch 202.

The main control unit 200 controls the entire operation of the image forming apparatus 1. On the other hand, the driving control unit 203 controls the operation of the image forming unit 3 in response to an instruction from the main control unit 200. For example, the driving control unit 203 controls a sensor, a motor, and a high-voltage substrate of the image forming unit 3 to perform image forming control and sheet conveyance control. Further, the main control unit 200 and the driving control unit 203 are connected to each other via a communication line 207.

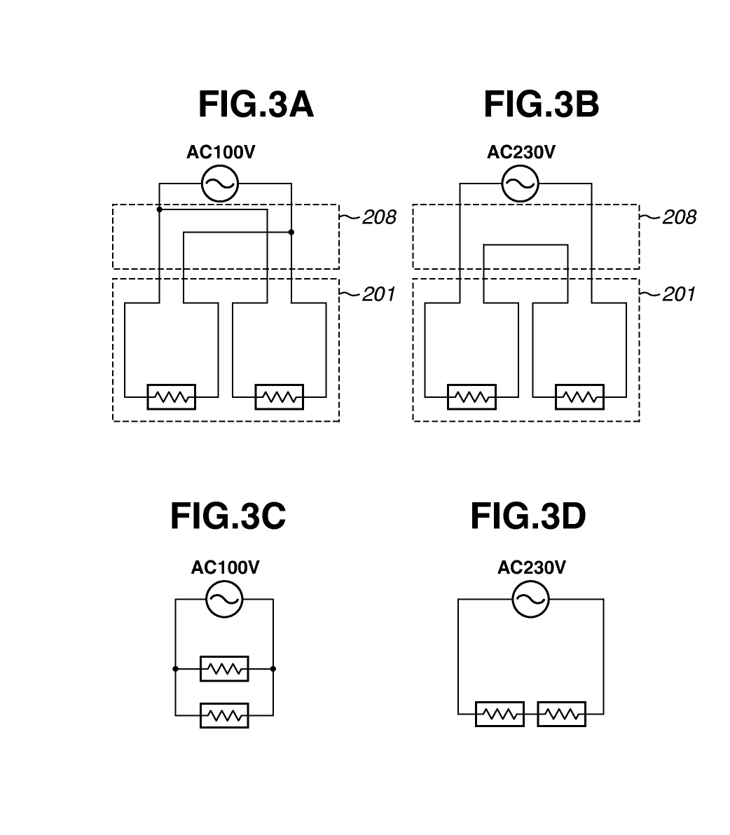

FIGS. 3A to 3D illustrate configurations of a universal cassette heater unit. FIG. 3A illustrates connection between the power supply 208 and the cassette heater unit 201, which is a universal type, in a case where the image forming apparatus 1 has a destination-specified power supply of 100 V, and FIG. 3C is an equivalent circuit diagram of FIG. 3A. On the other hand, FIG. 3B illustrates connection between the power supply 208 and the cassette heater unit 201, which is a universal type, in a case where the image forming apparatus 1 has a destination-specified power supply of 230 V, and FIG. 3D is an equivalent circuit diagram of FIG. 3B. The cassette heater unit 201 is an alternate current heater that generates heat when an alternate current voltage is applied thereto.

As illustrated in FIGS. 3A and 3B, the cassette heater unit 201 includes two heater wires each having a linear heating element (i.e., heating wire). The configuration of the cassette heater unit 201 for the image forming apparatus 1 for 100 V is similar to that for the image forming apparatus 1 for 230 V. In contrast, how to supply power from the image forming apparatus 1 is different between when the power supply 208 is 100 V and when the power supply 208 is 230 V. As illustrated in FIG. 3A, in the case of the power supply 208 for 100V, 100 V is applied to each of the two heater wires. In other words, as illustrated in FIG. 3C, the respective heating wires of the two heater wires are connected in parallel with respect to the power supply 208. On the other hand, as illustrated in FIG. 3B, in the case of the power supply 280 for 230V, 230 V is applied to the two heater wires in series. In other words, as illustrated in FIG. 3D, the respective heating wires of the two heater wires are connected in series with respect to the power supply 208. A configuration for such serial or parallel connection is provided inside the power supply 208, and the power supply 208 is configured so that power from the alternate current power source is supplied in either one of the connection states, depending on the destination of the image forming apparatus 1. In other words, the power supply 208 functions as a supply unit that supplies power to the cassette heater unit 201.

Therefore, in a case where the image forming apparatus 1 has a destination-specified power supply of 100 V, 100 V is applied to each of the two heater wires, and in a case where the image forming apparatus 1 has a destination-specified power supply of 230 V, 115 V is applied to each of the two heater wires. For example, in a case where a heater wire having a resistance value of 1725 ohms (Ω) is used, the power consumption of the heater wire at 100 V is 11.6 W, and the power consumption of the heater wire at 230 V is 15.3 W. Thus, strictly speaking, the generated heat amounts are not equal to each other. However, since the purpose of the configuration is to keep the moisture content of the recording sheet S stored in the cassette 18 below a certain level, the above-described difference in the power consumption is not a practically significant problem. This configuration does not require the use of different heater wires depending on the destination-specified power supply, and realizes a universal cassette heater unit capable of selectively inputting any one of voltages having different effective values from the alternate current power source thereto.

Herein, the two heater wires having substantially identical resistance values, i.e., the components having a similar specification, are used. However, the configuration may be such that the two heater wires have different resistance values. However, in the case of the configuration in which similar components are used as described above, a failure such as attaching an improper wire to the cassette heater unit 201 at the time of manufacture can be prevented, and at the same time, the number of kinds of components that should be managed in the manufacture can be decreased.

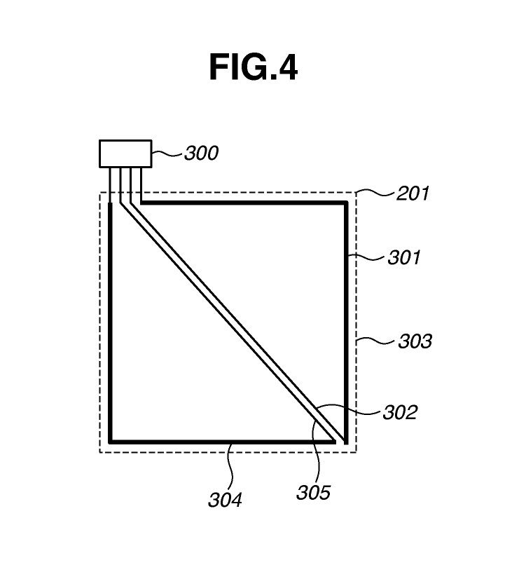

FIG. 4 illustrates a wiring arrangement of the cassette heater unit 201, which is a universal type, according to the present exemplary embodiment. The cassette heater unit 201 includes a power supply connector 300, a metal plate 303, and two heater wires. One of the two heater wires includes a heating wire 301 and a power supply wire 302, and the other one includes a heating wire 304 and a power supply wire 305. The power supply connector 300 receives power from the power supply 208, and is connected to both ends of each of the two heater wires, so as to function as an interface with the power supply 208 of the image forming apparatus 1. By switching the method for supplying power to the power supply connector 300 from the image forming apparatus 1, depending on the destination-specified power supply as mentioned above, the cassette heater unit 201 can serve as a universal cassette heater.

The metal plate 303 supports the two heater wires, and when the metal plate 303 is warmed by the heating wires 301 and 304, the metal plate 303 transfers the heat generated by the heating wires 301 and 304 uniformly over the surface thereof. Thus, the metal plate 303 serves as a heat transfer plate. With the heat of the metal plate 303, the recording sheet S in the cassette 18 can be heated and dried.

The power supply wires 302 and 305 of the two heater wires do not generate heat themselves, and are connected to the heating wires 301 and 304 in series, respectively so as to receive power from the power supply connector 300 and energize the heating wires 301 and 304, respectively. Terminals of the power supply connector 300 are arranged in the following order: a terminal for the heating wire 304, a terminal for the power supply wire 305, a terminal for the power supply wire 302, and a terminal for the heating wire 301. The heating wires 301 and 304 are arranged substantially along an outer periphery of the metal plate 303 so as not to overlap each other. According to the wiring arrangement example illustrated in FIG. 4, the heating wire 301 is arranged along two adjacent edges of the metal plate 303, and the heating wire 304 is arranged along the other two adjacent edges thereof. This configuration can suppress temperature unevenness in the entire part of the metal plate 303, and reduce the required total length of the heating wires 301 and 304. The power supply wires 302 and 305 are arranged so as to pass inside a path formed by the two heating wires 301 and 304 and to be connected to the power supply connector 300. This configuration can reduce the total length of the power supply wires 302 and 305, which do not contribute to heat generation.

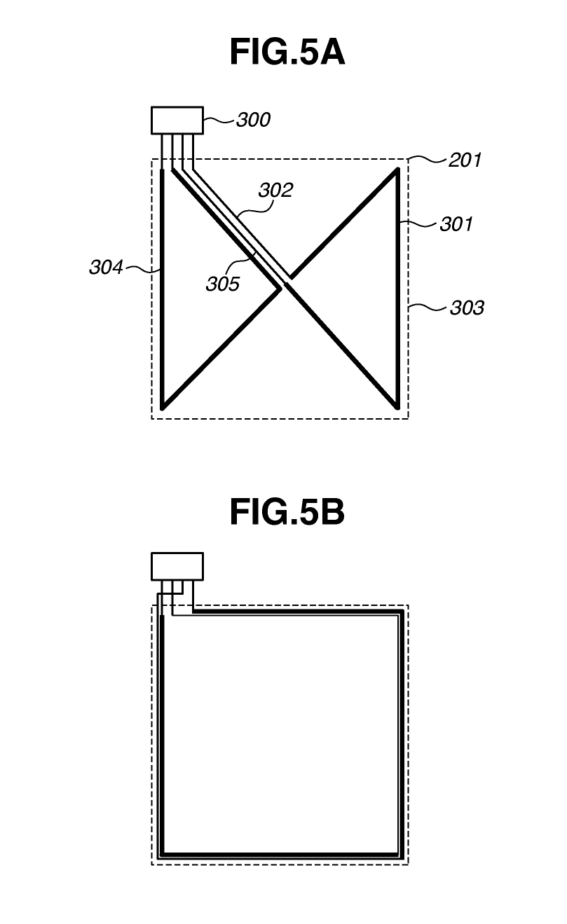

FIGS. 5A and 5B illustrate wiring arrangement examples of a conventional universal cassette heater unit. First, in FIG. 5A, the two heating wires 301 and 304 are arranged to form triangle paths on the right and left sides, respectively. In this case, the arrangement of the heating wires 301 and 304 is partially dense and partially sparse, whereby temperature unevenness is likely to occur in the metal plate 303. For example, the center of the lower edge of the metal plate 303 has a lower density of the heating wires 301 and 304, compared to the center portion of the metal plate 303, and temperature unevenness is more likely to occur than the example illustrated in FIG. 4. On the other hand, in FIG. 5B, the two heating wires 301 and 304 are arranged substantially along the outer periphery of the metal plate 303, as is the case with the heater unit illustrated in FIG. 4. The power supply wires 302 and 305, however, are also arranged substantially along the outer periphery of the metal plate 303, similarly to the heating wires 301 and 304. Therefore, the total length of the power supply lines 302 and 305, which do not contribute to heat generation, is greater than that of the wiring arrangement example illustrated in FIG. 4, resulting in increased cost. Therefore, as compared to the conventional universal cassette heater units illustrated in FIGS. 5A and 5B, the universal cassette heater unit illustrated in Fig. is capable of efficiently drying sheets with reduced temperature unevenness, and further achieving the cost reduction with a decreased wiring length.

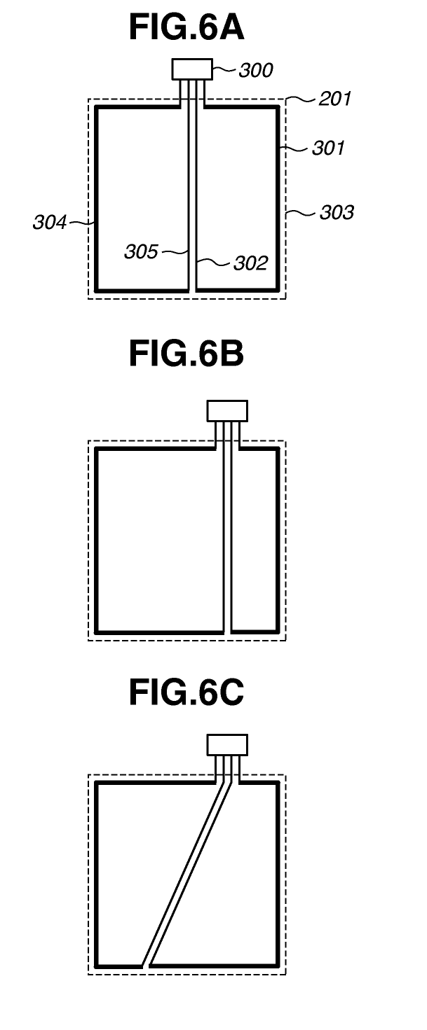

Although the configuration illustrated in FIG. 4 has been described as an example, the configuration is not limited to this, as long as it is in line with the idea behind the above-described wiring arrangement. Thus, other configuration examples will be described below with reference to FIGS. 6A to 6C.

FIG. 6A illustrates an arrangement example of the power supply connector 300 according to another exemplary embodiment. The arrangement of the heater wires is based on the same idea as that of FIG. 4, in which the heating wires 301 and 304 are arranged substantially along the outer periphery of the metal plate 303, and the power supply wires 302 and 305 are arranged inside the path formed by the heating wires 301 and 304.

FIG. 6B illustrates an example in a case where the two heater wires are different from each other. In order to reduce the production cost of the cassette heater unit, it is desirable that two identical heater wires are used and the quantity of the identical heater wires to be used is increased. However, in a case where two heater wires having different lengths are unavoidably used, the heater wires may be arranged with the difference taken into consideration, as is the case with the example illustrated in FIG. 6B.

FIG. 6C illustrates an example in a case where the power supply connector 300 is located not at the center or at the left end. In this case as well, the heater wires may be arranged based on the same idea as that in the case of FIG. 4, in which the heating wires 301 and 304 are arranged substantially along the outer periphery of the metal plate 303, and the power supply wires 302 and 305 are arranged inside the path formed by the heating wires 301 and 304.

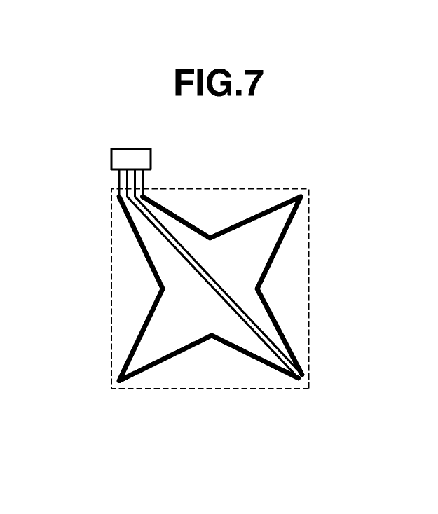

FIG. 7 illustrates a wiring arrangement example in the case of considering the reduction of temperature unevenness of the metal plate 303. In a case where the heating wires 301 and 304 are arranged along the outer periphery of the metal plate 303, depending on the size of the metal plate 303 or the characteristics of the heating wires 301 and 304, the center of the metal plate 303 may not be easily warmed. To cope with this, the path of the heating wires 301 and 304 is modified so as to be closer to the center of the metal plate 303, as compared to the example illustrated in FIG. 4, so that temperature unevenness between the center portion and the outer peripheral portion can be reduced.

In the foregoing description, the case where the metal plate has a square shape has been described, but the shape is not limited to this. Even in a case where the metal plate has a shape of not a square, but a circle, an ellipse, or a trapezoid, the two heating wires may be arranged based on the idea that the heating wires are arranged substantially along the outer periphery of the metal plate and the power supply lines are arranged inside the path formed by the heating wires.

According to the present exemplary embodiment, the heating wires are arranged substantially along the outer periphery of the metal plate, and the power supply wires are arranged inside the path formed by the heating wires, thereby suppressing temperature unevenness of the metal plate while reducing the wiring length. Thus, there can be provided a universal heater unit that efficiently dries sheets while achieving cost reduction.

According to the exemplary embodiments of the present invention, optimally arranging a plurality of heater wires in a heater unit can provide a heater unit capable of suppressing temperature unevenness while achieving cost reduction with a decreased wiring length.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-160335 filed Aug. 1, 2013, which is hereby incorporated by reference herein in its entirety.

What is claimed is:

1. A heater unit for heating a sheet stored in a cassette, the heater unit comprising:
a plurality of heater wires each including a heating wire and a power supply wire connected to the heating wire in series and configured to energize the heating wire;
a connector configured to supply power to the plurality of heater wires, wherein both ends of each of the plurality of heater wires are connected to the connector; and
a heat transfer plate through which heat of the plurality of heater wires is transferred, wherein on the heat transfer plate, the respective heating wires of the plurality of heater wires are arranged substantially along an outer periphery of the heat transfer plate so as not to overlap each other, and the respective power supply wires of the plurality of heater wires are arranged inside a path formed by the heating wires of the plurality of heater wires.

2. The heater unit according to claim 1, wherein the heating wire of each of the plurality of heater wires is arranged along at least two adjacent edges of the heat transfer plate.

3. The heater unit according to claim 1, wherein the plurality of heater wires has a similar specification.

4. The heater unit according to claim 1, wherein the plurality of heater wires includes a first heater wire and a second heater wire, and a plurality of terminals of the connector is arranged in an order of a terminal for a heating wire of the first heater wire, a terminal for a power supply wire of the first heater wire, a terminal for a power supply wire of the second heater wire, and a terminal for a heating wire of the second heater wire.

5. The heater unit according to claim 1, wherein any one of voltages having different effective values is supplied from a commercial alternate current power source to each of the plurality of heater wires.

6. An image forming apparatus comprising:
a heater unit for heating a sheet stored in a cassette, the heater unit including,
a plurality of heater wires each including a heating wire and a power supply wire connected to the heating wire in series and configured to energize the heating wire,
a connector configured to supply power to the plurality of heater wires, wherein both ends of each of the plurality of heater wires are connected to the connector, and
a heat transfer plate through which heat of the plurality of heater wires is transferred, wherein on the heat transfer plate, the respective heating wires of the plurality of heater wires are arranged substantially along an outer periphery of the heat transfer plate so as not to overlap each other, and the respective power supply wires of the plurality of heater wires are arranged inside a path formed by the heating wires of the plurality of heater wires; and

7. The image forming apparatus according to claim 6, further comprising a supply unit configured to supply power from an alternate current power source to the connector of the heater unit,
wherein in a case where the image forming apparatus is connected to an alternate current power source of a first voltage, the supply unit is connected to a plurality of terminals of the connecter in a state equivalent to a state where the plurality of heater wires is connected in parallel, and in a case where the image forming apparatus is connected to an alternate current power source of a second voltage higher than the first voltage, the supply unit is connected to the plurality of terminals of the connecter in a state equivalent to a state where the plurality of heater wires is connected in series.

8. The image forming apparatus according to claim 6, wherein the heating wire of each of the plurality of heater wires is arranged along at least two adjacent edges of the heat transfer plate.

9. The image forming apparatus according to claim 6, wherein the plurality of heater wires has a similar specification.

10. The image forming apparatus according to claim 6, wherein the plurality of heater wires includes a first heater wire and a second heater wire, and the plurality of terminals of the connector is arranged in an order of a terminal for a heating wire of the first heater wire; a terminal for a power supply wire of the first heater wire; a terminal for a power supply wire of the second heater wire; and a terminal for a heating wire of the second heater wire.
